(19) United States
(12) Patent Application Publication
(10) Pub. No.: US 2025/0225726 A1
(43) Pub. Date: Jul. 10, 2025

(54) USING AN ISO BMFF FILE TO STORE 3D OBJECT MODEL DATA

(71) Applicant: QUALCOMM Incorporated, San Diego, CA (US)

(72) Inventors: Imed Bouazizi, Celina, TX (US); Michel Adib Sarkis, San Diego, CA (US); Nikolai Konrad Leung, San Francisco, CA (US); Thomas Stockhammer, Bergen (DE)

(21) Appl. No.: 19/008,368

(22) Filed: Jan. 2, 2025

Related U.S. Application Data
(60) Provisional application No. 63/617,715, filed on Jan. 4, 2024.

(51) Int. Cl. G06T 17/00

(52) U.S. Cl. CPC G06T 17/00; G06T 2210/32; G06T 2210/36

(57) ABSTRACT

An example device for retrieving media data includes a memory for storing media data; and a processing system implemented in circuitry and configured to: retrieve data representing a three-dimensional (3D) object model and one or more levels of detail (LODs) for the 3D object model; send a request to the server device to access data for the 3D object model at one of the LODs, the data for the 3D object model at the one of the LODs including a size, complexity, and components of the 3D object model for the one of the LODs; and receive the data for the 3D object model at the one of the LODs in response to the request, the data for the 3D object model at the one of the LODs having the size, the complexity, and the components of the 3D object model for the one of the LODs.

This application claims the benefit of U.S. Provisional Application No. 63/617,715, filed Jan. 4, 2024, the entire contents of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format (BMFF) and extensions thereof, such as AVC.

### SUMMARY

In general, this disclosure describes techniques for using an ISO Base Media File Format (ISO BMFF) file to store 3D object models, such as user avatars, involved in an extended reality (XR) session. For example, various levels of detail (LODs) of the 3D object model may be stored, including for each LOD, components of the model at that LOD. In this manner, the base model can be distributed to users involved in the XR session, then modified using animation streams. That is, when a user of a device (e.g., a user equipment (UE) device) participates in an XR session with other users, the user's device may share a base 3D object model with the other users, then send animation streams to animate the 3D object model.

This disclosure is directed to techniques for efficiently storing the base model for fast distribution and adaptation to each participant's network connection and processing capabilities. In particular, the device may determine a particular LOD for the 3D object model to retrieve based on, e.g., a distance to the 3D object in the 3D scene, available network bandwidth, or the like, then retrieve the determined LOD for the 3D object model. In this manner, relatively lower LOD models may be retrieved when the 3D object is relatively far from the current user, whereas relatively higher LOD models may be retrieved when the 3D object is relatively close to the current user. Therefore, relatively lower LOD models may be accessed and processed quickly for objects that do not require high amounts of detail (e.g., due to being far away from the current user), and thus, processing resources may be prioritized for relatively higher LOD models for 3D objects that are close to the current user. Thus, these techniques may reduce processing operations and bandwidth required for 3D objects needing to be rendered, while maintaining a good experience for the user because nearby 3D objects can be rendered at a higher quality level.

In one example, a method of storing media data includes: storing a three-dimensional (3D) object model in an ISO base media file format (ISO BMFF) file, including: storing metadata for the 3D object model in the ISO BMFF file; storing a number of levels of detail (LODs) for the 3D object model in the ISO BMFF file; and for each of the number of LODs, storing data associating the LOD with data representing a size, complexity, and components of the 3D object model for the LOD in the ISO BMFF file.

In another example, a device for storing media data includes: a memory for storing media data; and a processing system implemented in circuitry and configured to store a three-dimensional (3D) object model in an ISO base media file format (ISO BMFF) file of the media data in the memory, wherein to store the 3D object model in the ISO BMFF file, the processing system is configured to: store metadata for the 3D object model in the ISO BMFF file; store a number of levels of detail (LODs) for the 3D object model in the ISO BMFF file; and for each of the number of LODs, store data associating the LOD with data representing a size, complexity, and components of the 3D object model for the LOD in the ISO BMFF file.

In another example, a method of retrieving media data includes: retrieving, by a client device, data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device; sending, by the client device, a request to the server device to access data for the 3D object model at one of the LODs, the data for the 3D object model at the one of the LODs including a size, complexity, and components of the 3D object model for the one of the LODs; and receiving, by the client device, the data for the 3D object model at the one of the LODs in response to the request, the data for the 3D object model at the one of the LODs having the size, the complexity, and the components of the 3D object model for the one of the LODs.

In another example, a device for retrieving media data includes: a memory for storing media data; and a processing system implemented in circuitry and configured to: retrieve data representing a three-dimensional (3D) object model and one or more levels of detail (LODs) for the 3D object model; send a request to the server device to access data for the 3D object model at one of the LODs, the data for the 3D object model at the one of the LODs including a size, complexity, and components of the 3D object model for the one of the LODs; and receive the data for the 3D object model at the one of the LODs in response to the request, the data for the 3D object model at the one of the LODs having the size, the complexity, and the components of the 3D object model for the one of the LODs.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a flow diagram illustrating an example avatar animation workflow that may be used during an XR session.

FIG. 4 is a flow diagram illustrating an example XR session between two user equipment (UE) devices and a shared space server device.

FIG. 5 is a block diagram illustrating an example 3D object model structure that may be stored in an ISO Base Media File Format (ISO BMFF) file according to the techniques of this disclosure.

FIG. 6 is a block diagram illustrating an example base model mapping structure that may be included in the 3D object model structure of FIG. 5 according to the techniques of this disclosure.

FIG. 7 is a block diagram illustrating an example base model component structure that may be included in the base model mapping structure of FIG. 6 according to the techniques of this disclosure.

FIG. 8 is a flow diagram illustrating an example method that may be used to store, send, and retrieve data of a 3D object model structure according to the techniques of this disclosure.

FIG. 9 is a flowchart illustrating an example method of generating an ISO base media file format (ISO BMFF) file including a base model of a 3D object at various levels of detail according to techniques of this disclosure.

FIG. 10 is a flowchart illustrating an example method of retrieving 3D object media data according to techniques of this disclosure.

### DETAILED DESCRIPTION

In general, this disclosure describes techniques for storing and transporting three-dimensional (3D) object model data, such as avatar model data, which may be used in an extended reality (XR) session. The XR session may be an augmented reality (AR), mixed reality (MR), or virtual reality (VR) session. The XR session may be between two or more participants, each using respective XR-capable devices, e.g., user equipment (UE) devices.

Immersive XR experiences are typically based on shared virtual spaces, where people (represented by their avatars) join and interact with each other and the environment. Avatars may be a realistic representation of the user, or may be a “cartoonish” representation. Avatars may be animated to mimic the user's body pose and facial expressions.

This disclosure generally describes storage and transport of 3D object models, such as user avatars, involved in an XR session. For example, various levels of detail (LODs) of the 3D object model may be stored, including for each LOD, components of the model at that LOD. In this manner, the base model can be distributed to users involved in the XR session, then modified using animation streams. That is, when a user of a device (e.g., a user equipment (UE) device) participates in an XR session with other users, the user's device may share a base 3D object model with the other users, then send animation streams to animate the 3D object model. This disclosure is generally directed to techniques for efficiently storing the base model for fast distribution and adaptation to each participant's network connection and processing capabilities. This disclosure also describes techniques by which data representing the 3D object model can be sent to (retrieved by) devices of other users involved in the XR session. While generally described with respect to storage and transport of user avatars, these techniques may generally be applied to other animatable 3D objects in the XR scene as well, such as non-user avatars, animatable or moveable objects in the XR scene, or the like.

As an example, a user of an XR device, such as an XR headset, may participate in an XR communication session with one or more other users, e.g., during an XR conference call, an XR game, or the like. Each of the users may have a respective avatar to be depicted to represent the user in the XR communication session. The avatar may be presented at a particular position in a 3D space. Each user may control their position in the 3D space by either physically moving (which may be tracked by the XR device) or using controllers or other input devices to provide movement input.

In general, a user will only be able to appreciate high level of detail models for, e.g., avatars or other 3D objects in the 3D space, when the 3D objects are close to the user in the 3D space. Thus, rather than retrieving high level of detail models for 3D objects that are relatively far away from the user in the 3D space, the XR device may retrieve lower LOD models. In this manner, bandwidth can be saved when retrieving lower LOD models, and processing demands for rendering the lower LOD models may be reduced. Therefore, such bandwidth and processing resources may be allocated for higher LOD models for 3D objects that are relatively close to the user in 3D space. Available network bandwidth may also be used to determine levels of detail for the 3D models, e.g., to ensure that data needed for each of the models can be retrieved in a timely manner.

After having retrieved LODs for each of the models, the XR device may receive information indicating an animation stream to be applied to the model. In this manner, the animation stream may remain agnostic as to the LOD for the model. That is, the same animation stream can be used for each of the LODs of the model.

The techniques of this disclosure may generally improve the efficiency of storage, transport, and rendering of 3D object models. The techniques of this disclosure may also allow for different representations of a 3D object model to be sent to different users, e.g., to accommodate varying network connection, available bandwidth, and processing capabilities.

The techniques of this disclosure may be applied to video files conforming to video data encapsulated according to ISO base media file format (BMFF) or extensions thereof. The techniques of this disclosure may be applied to other file formats as well, such as Scalable Video Coding (SVC) file format, Advanced Video Coding (AVC) file format, Third Generation Partnership Project (3GPP) file format, and/or Multiview Video Coding (MVC) file format, or other similar video file formats.

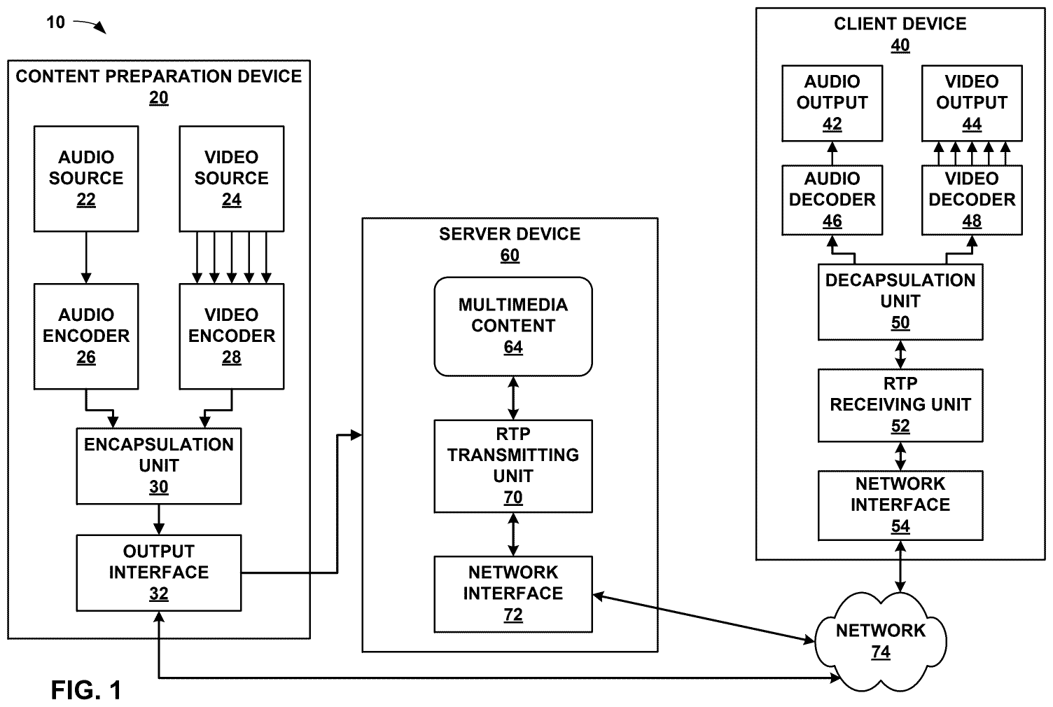

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

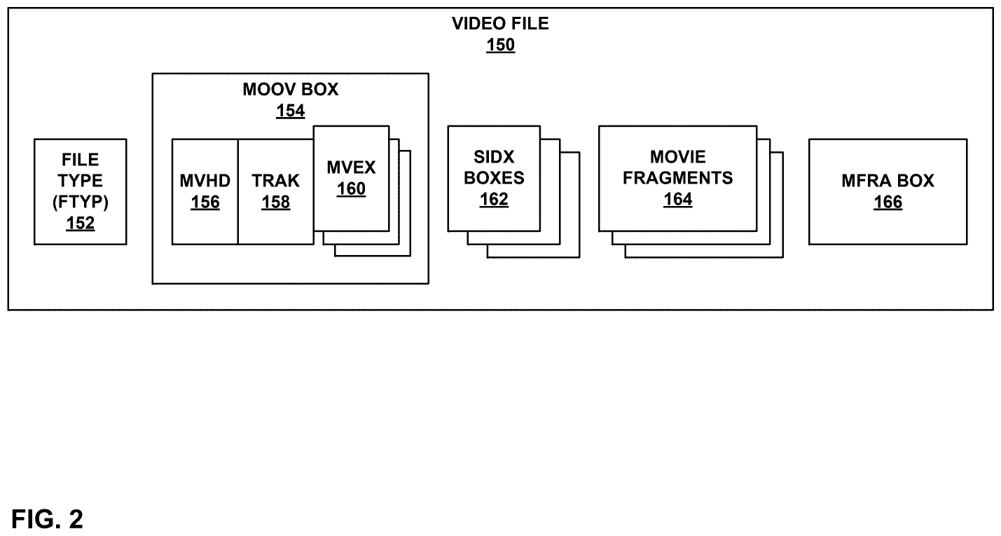

FIG. 2 is a block diagram illustrating elements of an example video file 150. As described above, video files in accordance with the ISO base media file format (BMFF) and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO BMFF and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

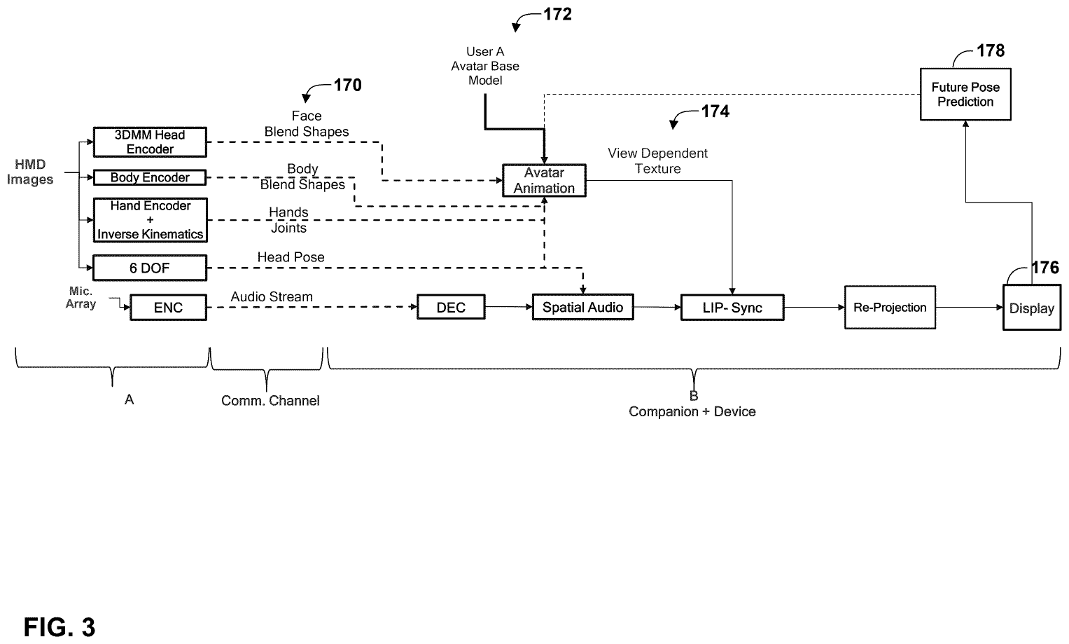

FIG. 3 is a flow diagram illustrating an example avatar animation workflow that may be used during an XR session. In this example, received animation stream data 170 includes face blend shapes, body blend shapes, hand joints, head pose, and audio stream data. The face blend shapes, body blend shapes, and hand joints may correspond to animation streams to be applied to user A avatar base model 172. In particular, data for user A avatar base model 172 may be stored at various levels of detail, per the techniques of this disclosure. Thus, rendering components 174 may retrieve data of user A avatar base model 172 at an appropriate level of detail, e.g., based on a distance between a current user and user A in a 3D space. Rendering components 174 may then animate the avatar base model using received animation stream data 170. Ultimately, the animated avatar base model may be presented to the current user via display 176. In addition, movement data of the current user may be used to predict a future pose of the user by future pose prediction unit 178.

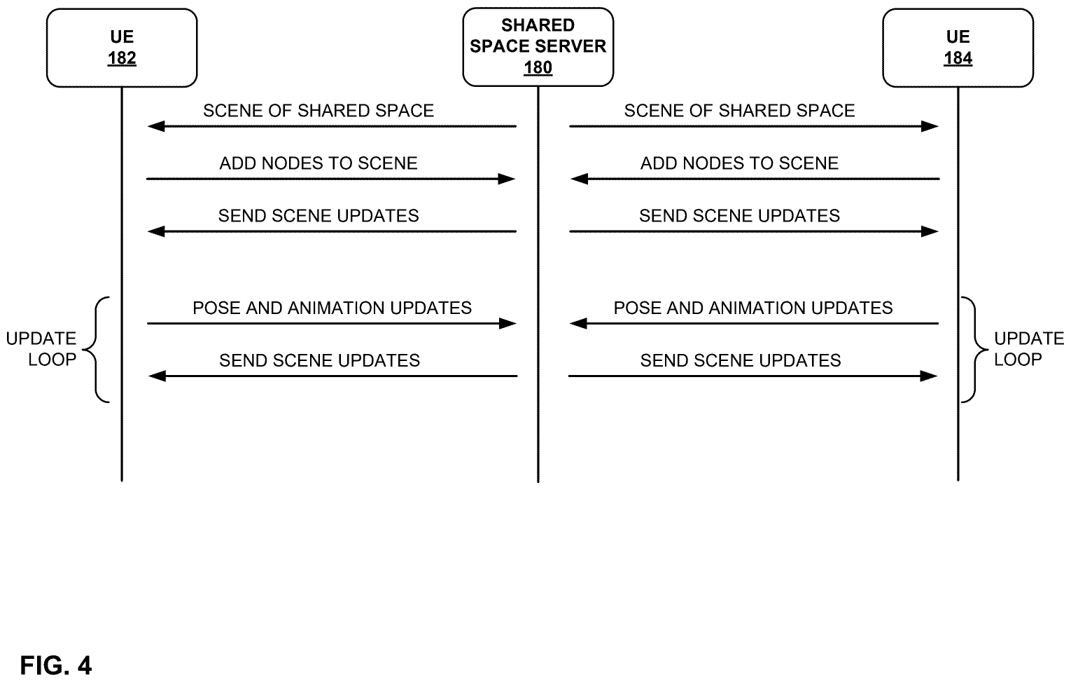

FIG. 4 is a flow diagram illustrating an example XR session between two user equipment (UE) devices and a shared space server device. As shown in the example of FIG. 4, two or more UEs may participate in an XR session. The UEs may send and receive data representative of their animation streams and other 3D model data to and from a shared space server. For example, various sensors such as cameras, trackers, LIDAR, or the like, may track user movements, such as facial movements (e.g., during speech or as emotional reactions), hand movements, walking movements, or the like. These movements may be translated into an animation stream by, e.g., UE 182 and sent to the shared space server. The shared space server may then send the animation stream to UE 184.

UE 184 may determine a distance between a user of UE 184 in a 3D space for the XR session and a user of UE 182 in the 3D space for the XR session. User positions may be represented by 3D vectors relative to an origin point for the 3D space. Thus, the user of UE 182 may be at position {x1, y1, z1} in the 3D space, and the user of UE 184 may be at position {x2, y2, z2} in the 3D space. The distance between the user of UE 182 and the user of UE 184 may be calculated as:

$$Distance = \sqrt{{( x 2 - x 1 )}^{2} + {( y 2 - y 1 )}^{2} + {( z 2 - z 1 )}^{2}}$$

UE 184 may use this distance to determine an appropriate LOD of a 3D object model for an avatar of the user of UE 182 to request from the shared space server. For example, UE 184 may be configured with various thresholds corresponding to each available LOD for the 3D object model of the avatar. Thus, UE 184 may determine which threshold is satisfied by the determined distance, then request the LOD for the 3D object model for the avatar of the user of UE 182 corresponding to the threshold. UE 184 may then animate the retrieved version of the 3D object model having the requested LOD using animation streams received from UE 182 via the shared space server.

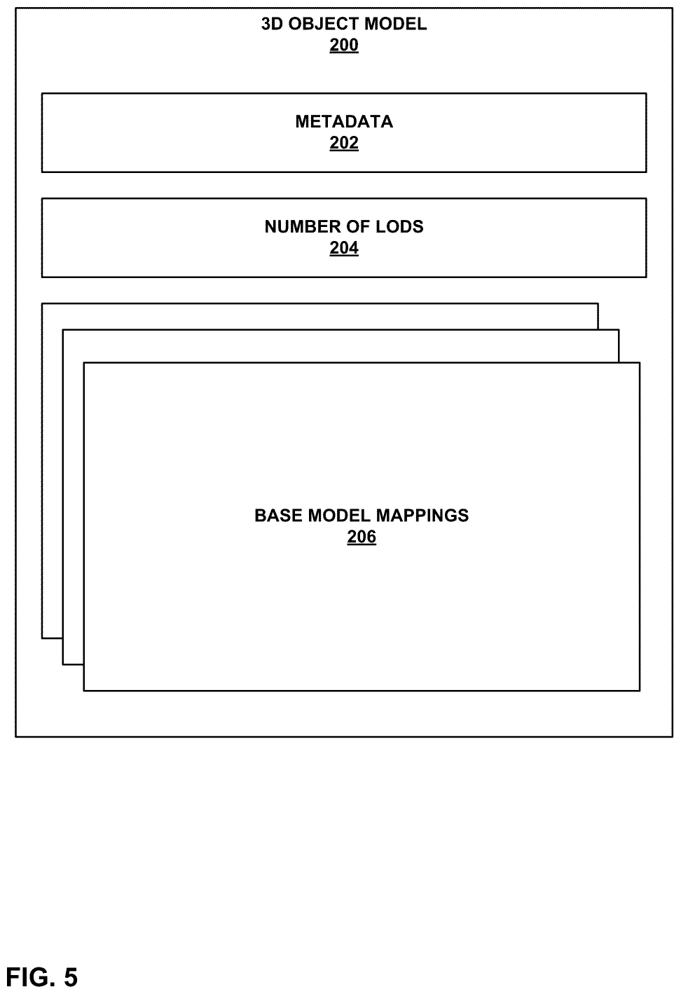

FIG. 5 is a block diagram illustrating an example 3D object model structure 200 that may be stored in an ISO Base Media File Format (ISO BMFF) file according to the techniques of this disclosure. For example, 3D object model structure 200 may be stored in video file 150 of FIG. 2. In general, this disclosure describes techniques for storing a 3D object model, such as an avatar base model, that may be used during an XR session in an ISO BMFF file. This disclosure also describes techniques for retrieving 3D object model data from an ISO BMFF file (or from a device that stores the 3D object model data in an ISO BMFF file).

The storage of a 3D object model in an ISO BMFF file according to the techniques of this disclosure may allow for extraction of a relevant representation based on a desired target size and complexity. For example, the 3D object model may be stored in a variety of different levels of detail (LODs), which may have different complexities, sizes, or the like. In this manner, for example, if a user is close to the 3D object represented by the 3D object model in a virtual scene, the user's device may retrieve a higher LOD representation of the 3D object, whereas if the user is relatively far away from the 3D object in the virtual scene, the user's device may retrieve a lower LOD representation of the 3D object.

The storage of a 3D object model in an ISO BMFF file according to the techniques of this disclosure may also allow for encryption of all, or just a subset of, a set of components of the 3D object model. In this manner, the 3D object model may be protected from copying or digital theft from users who are not authorized to access the 3D object model.

The 3D object model may include metadata including a description of all components of the 3D object model (e.g., an avatar) and provide the metadata to describe the base model.

FIG. 5 depicts an example 3D object model 200 including metadata 202, number of levels of detail (LODs) 204, and a set of base model mappings 206. Metadata 202 may include a primary item containing main metadata, such as name, type, gender, age, or other descriptive data for a user represented by an avatar corresponding to 3D object model 200. The set of base model mappings 206 may include one mapping for each of the number of LODs 204. For example, if number of LODs 204 has a value of five, then there may be five base model mappings 206. Base model mappings 206 may provide associations between LODs, a resulting size and complexity for a corresponding LOD, and components of the base model at the corresponding LOD.

The following pseudocode represents an example data structure corresponding to 3D object model 200:

```
aligned(8) class BaseAvatarModel extends FullBox(‘bavm’, version,
flags) {
  AvatarMetadataEntry( );
  unsinged int number_lods;
  BaseModelMapping mappings[number_lods];
}
```

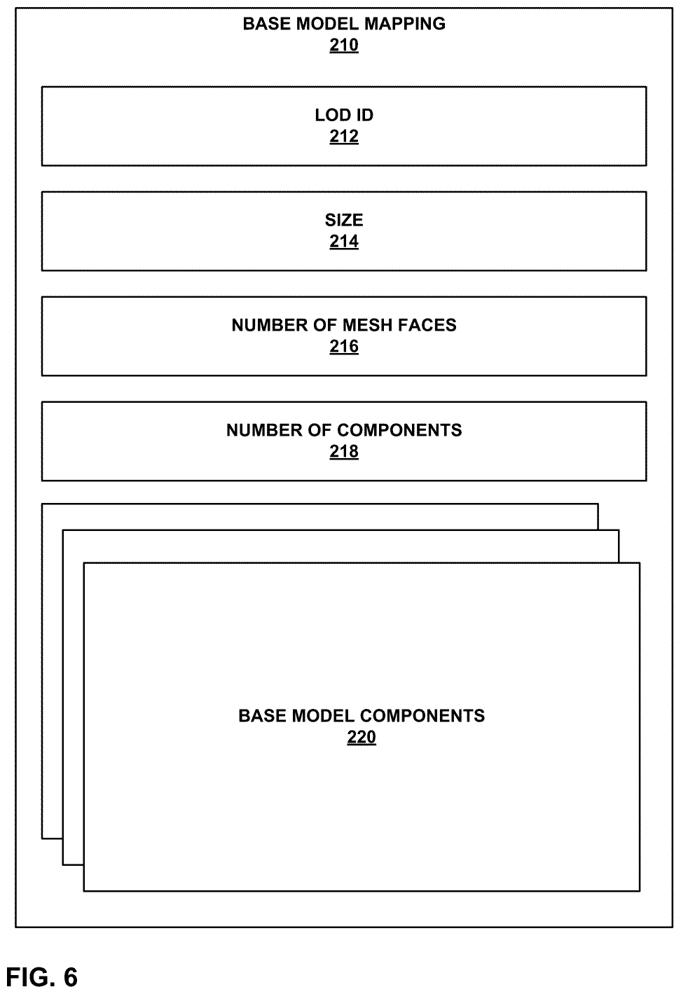

FIG. 6 is a block diagram illustrating an example base model mapping structure 210 that may be included in 3D object model structure 200 of FIG. 5 according to the techniques of this disclosure. That is, each of base model mappings 206 of FIG. 5 may include the elements of base model mapping 210 of FIG. 6. Base model mapping structure 210 includes LOD identifier (ID) 212, size 214, number of mesh faces 216, number of components 218, and base model components 220. Base model mapping 210 is associated with a level of detail (LOD) indicated by LOD ID 212. Size 214 provides information about a size and complexity of the corresponding LOD. Number of mesh faces 216 represents a number of faces (e.g., individual planar elements) of components of the LOD.

Number of components 218 describes a number of base model component structures 220 included in base model mapping 210. Base model components 220 represent a list of components of the base model at the LOD. The number of base model components 220 may be equal to the value of number of components 218. Maps may be available at different resolutions and may be stored as image items. Base model components 220 may be compressed. For example, geometry data may be compressed using mesh compression, images may be compressed using an image or video compression standard, such as JPEG, ITU-T H.264, ITU-T H.265, ITU-T H.266, or the like, and other data may be entropy coded.

The following pseudocode represents an example data structure corresponding to base model mapping 210:

```
aligned(8) class BaseModelMapping extends FullBox(“bmma”, version,
flags) {
  unsigned int(16) lod_id;
  unsinged int(32) size_in_bytes;
  unsigned int(32) num_mesh_faces;
  unsinged int(16) num_components;
  BaseModelComponent components[num_components];
}
```

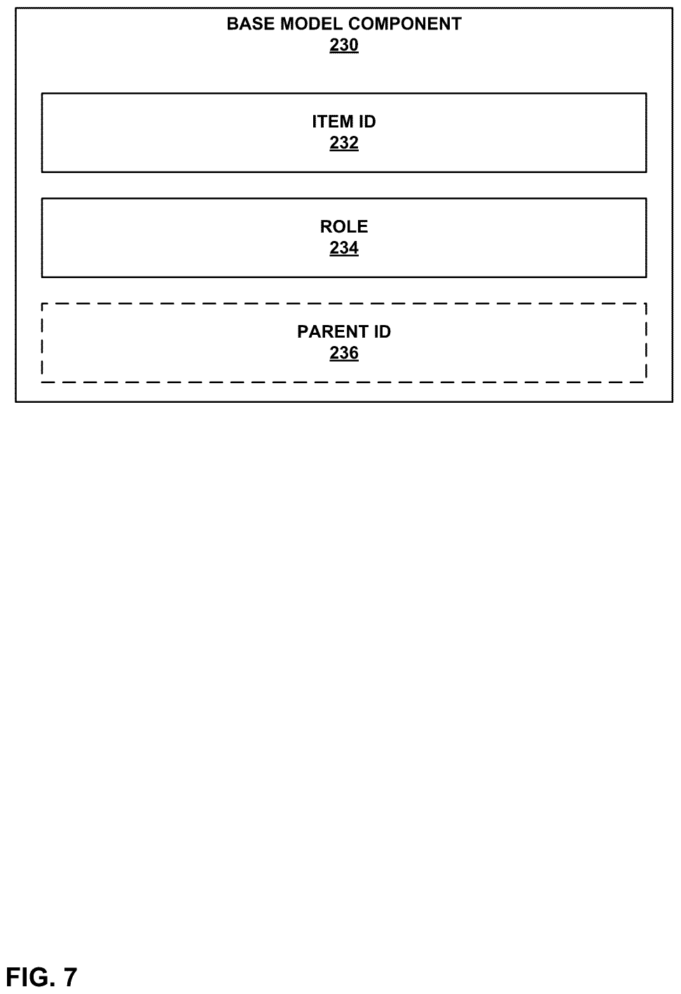

FIG. 7 is a block diagram illustrating an example base model component structure 230 that may be included in base model mapping structure 210 of FIG. 6 according to the techniques of this disclosure. That is, each of base model components structures 220 of FIG. 6 may include the elements of base model component structure 230 of FIG. 7. In this example, base model component 230 includes item identifier (ID) 232, role 234, and parent ID 236 (which is an optional element, as signified by dashed lines in FIG. 7).

Components may be assigned roles that describe their roles for the base model, as indicated by role 234. Examples of roles include a joint, a blendshape, a mesh, a map, or a pose transform. Each component may be stored separately as a metadata item. Each component may include an ItemInfoEntry that describes its content_type and content_encoding, which indicates what (if any) compression scheme was applied. Each component may also be encrypted individually. Components may be arranged hierarchically and can indicate their respective parent items using the value of parent ID 236.

The following pseudocode represents an example data structure corresponding to base model component 230:

```
aligned(8) class BaseModelComponent extends FullBox(“bmcp”, version,
flags)
{
  unsigned int(16) item_ID;
  Role role;
  unsigned int(16) parent_item_ID; optional;
}
```

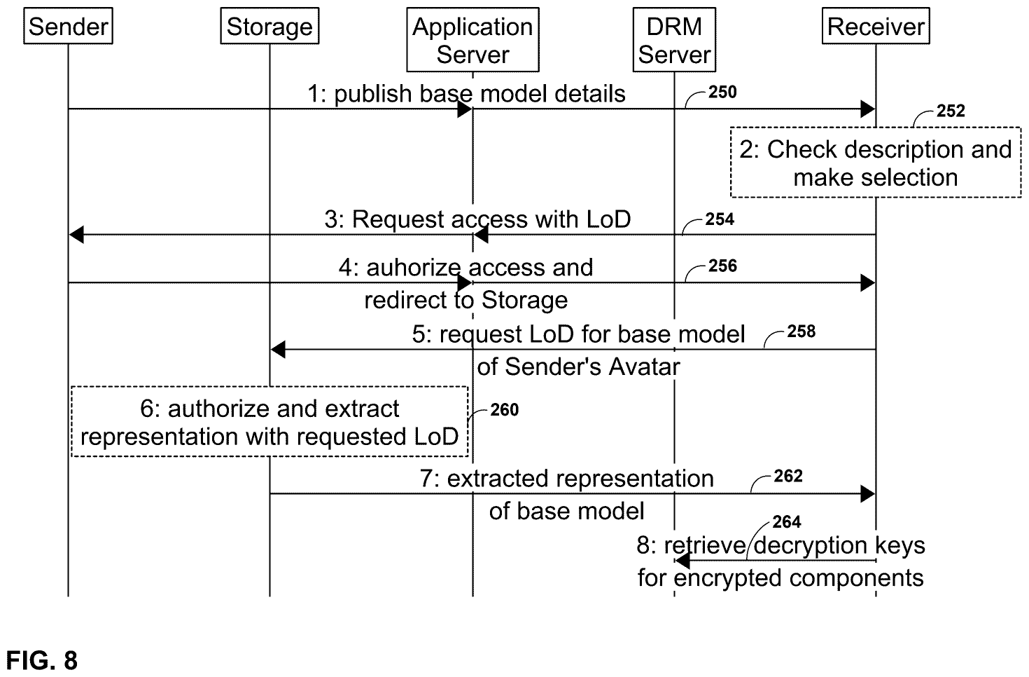

FIG. 8 is a flow diagram illustrating an example method that may be used to store, send, and retrieve data of a 3D object model structure according to the techniques of this disclosure. In this example, a sender (e.g., a first UE, such as content preparation device 20 of FIG. 1 or UE 182 of FIG. 4) publishes base model details (250), such as metadata for a 3D object model (e.g., avatar) and levels of detail available for the 3D object model to an application server (AS). The sender may publish an avatar description including a content type of a primary item, e.g., “application/mpeg.avatar.main.” The sender may also publish required decompression engines, information about required decryption, and available levels of detail. The sender may also store the 3D object model to a storage device, such as server device 60 of FIG. 1, in an ISO BMFF file according to the techniques of this disclosure (e.g., conforming to the examples of FIGS. 5-7). That is, the sender may store various versions of the base model at each of the levels of detail.

A receiver (e.g., client device 40 of FIG. 1) may retrieve a description of the base model details from the AS. The receiver may check the description and make a selection of one of the LODs (252). For example, the receiver may determine the LOD based on a proximity (distance) of a user of the receiver to the 3D object in the virtual scene, available network bandwidth, processing capabilities, or the like. The receiver may also ensure the ability to decode the components. The receiver may then request access to the selected LOD from the AS (254). The AS may direct the request to the sender. In this manner, the receiver may signal a request for the selected LOD of the 3D object model to the sender.

The sender may then authorize the receiver to access the 3D object model at the requested LOD (256). The sender may redirect the request to a storage device (e.g., server device 60 of FIG. 1). The storage device may extract the relevant representation from the ISO BMFF file based on the request and redirect the request to proper license servers for decryption keys.

The receiver may then request the LOD for the 3D object model (e.g., the sender's avatar) from the storage device (258). The storage device may authorize and extract the representation with the requested LOD from the ISO BMFF file (260) and send the extracted representation of the base model (at the requested LOD) to the receiver (262). If one or more of the components of the LOD are encrypted, the receiver may retrieve decryption keys for the encrypted components from a digital rights management (DRM) server device (262). The receiver may then decrypt the encrypted components and use the components of the LOD to present the base model (264).

During an XR session between the sender and receiver, the sender may send animation data to the receiver. The receiver may use the animation data to transform and/or warp the base model and display these animations to a user of the receiver via a display device.

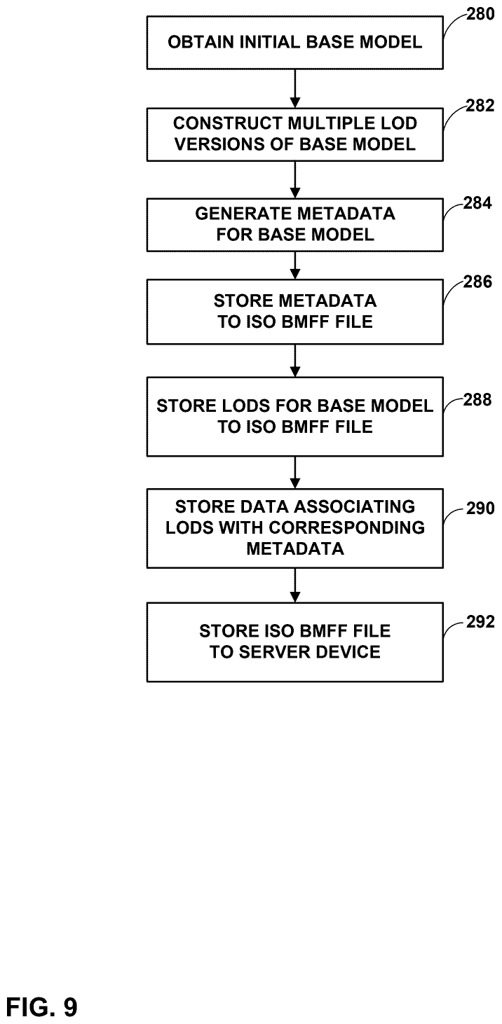

FIG. 9 is a flowchart illustrating an example method of generating an ISO base media file format (ISO BMFF) file including a base model of a 3D object at various levels of detail according to techniques of this disclosure. The method of FIG. 9 may be performed by a server device, such as server device 60 of FIG. 1, client device 40 of FIG. 1, and/or a source user equipment (UE) device, such as UE 182 of FIG. 4. The method of FIG. 9 may be performed by each UE that participates in a multi-user XR communication session, and thus, the method of FIG. 9 may be performed by both UE 182 and UE 184 of FIG. 4.

Initially, a source device obtains an initial base model (280) of a 3D object, such as a user avatar. For example, a user may create the base model, download the base model, store the base model, modify an existing model, or otherwise load and/or construct the base model. The source device may then construct multiple level of detail (LOD) versions of the base model (282). For example, the source device may construct one or more reduced LOD versions from the initial base model. To reduce the LOD, the source device may reduce texture resolutions, reduce numbers of polygons (e.g., numbers of vertices/edges/triangles) of the model (which may thereby reduce a number of model faces to which textures are applied), reduce a number of components of the model, reduce a size of the model, or the like.

The source device may then generate metadata for the base model (284). The metadata may generally indicate information representing the number of LOD versions of the base model that are available and characteristics for each of the LOD versions. For example, the metadata may indicate, for each LOD version, a size of the base model for that LOD version, a number of mesh faces for that LOD version, and a number of components for that LOD version. The metadata may also include mapping data that maps the metadata for each LOD version to the corresponding LOD version, e.g., using LOD identifier values, as shown in FIG. 6.

The source device may then store the metadata to an ISO BMFF file (286), as well as each of the LOD versions for the base model to the ISO BMFF file (288). The source device may also store data associating the metadata for each LOD with the corresponding LOD, e.g., using LOD identifiers (290). The source device may also store the ISO BMFF file to a server device (292).

In this manner, the method of FIG. 9 represents an example of a method of storing media data, including: storing a three-dimensional (3D) object model in an ISO base media file format (ISO BMFF) file, including: storing metadata for the 3D object model in the ISO BMFF file; storing a number of levels of detail (LODs) for the 3D object model in the ISO BMFF file; and for each of the number of LODs, storing data associating the LOD with data representing a size, complexity, and components of the 3D object model for the LOD in the ISO BMFF file.

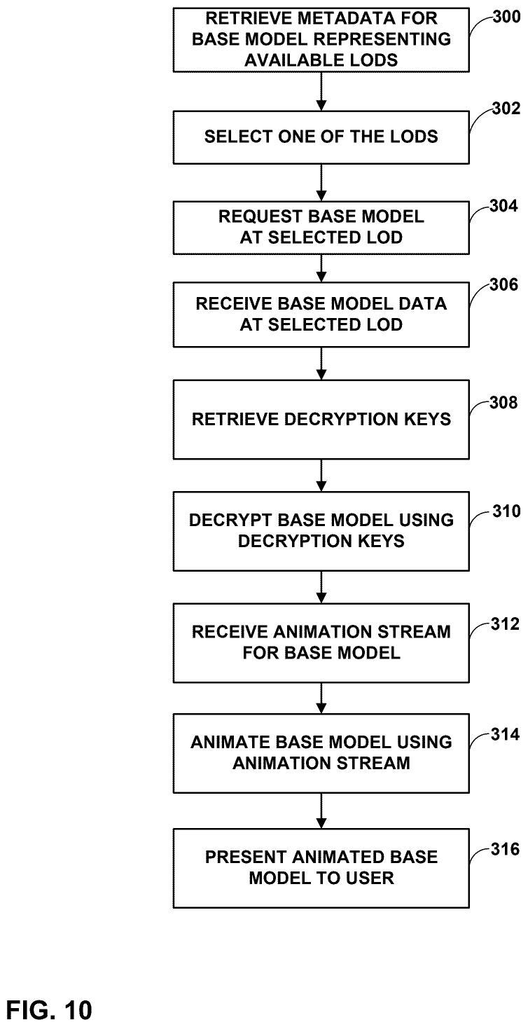

FIG. 10 is a flowchart illustrating an example method of retrieving 3D object media data according to techniques of this disclosure. The method of FIG. 10 may be performed by client device 40 of FIG. 1 or a user equipment (UE) device, such as UE 184 of FIG. 4. The method of FIG. 10 may be performed by each UE that participates in a multi-user XR communication session, and thus, the method of FIG. 10 may be performed by both UE 182 and UE 184 of FIG. 4.

A client device may initially retrieve metadata for a base model of a 3D object representing available level of detail (LOD) versions of the base model (300). As discussed above, the metadata may indicate, for example, a size for each LOD version, a number of mesh faces for each LOD version, a number of components for each LOD version, and a mapping between the indicated characteristics for each of the LOD versions and the LOD versions, e.g., using LOD identifiers for the LOD versions.

The client device may then select one of the LOD versions (302). For example, the client device may determine a distance between a user of the client device and a user for which the 3D object model is to be retrieved in a 3D space. In some examples, available network bandwidth may also be used when selecting the LOD version. The client device may then request the base model at the selected LOD (304). For example, the client device may request the base model from a storage device, such as a central avatar repository. In response to the request, the client device may receive the base model at the selected LOD (306). In some examples, if the base model is encrypted, the client device may further retrieve decryption keys (308) and use the decryption keys to decrypt the base model (310).

Furthermore, while participating in an XR communication session, the client device may retrieve an animation stream for the base model (312), e.g., as shown in FIG. 3. The animation stream may indicate face blend shapes, body blend shapes, hand joint movements, and/or head poses to be applied to the base model. The client device may then animate the base model using the animation stream (314). The client device may ultimately present the animated base model to a user of the client device (316), e.g., via a display. The animation stream may correspond to real-world movements of the user associated with the base model, such as facial movements (e.g., to represent speech), hand movements, body movements, or the like.

In this manner, the method of FIG. 10 represents an example of a method of retrieving media data, including: retrieving, by a client device, data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device; sending, by the client device, a request to the server device to access data for the 3D object model at one of the LODs, the data for the 3D object model at the one of the LODs including a size, complexity, and components of the 3D object model for the one of the LODs; and receiving, by the client device, the data for the 3D object model at the one of the LODs in response to the request, the data for the 3D object model at the one of the LODs having the size, the complexity, and the components of the 3D object model for the one of the LODs.

In this manner, the techniques of this disclosure allow for storage of a 3D object model (e.g., an avatar base model) in ISO BMFF files. These techniques may leverage the metadata structures of ISO BMFF to allow for efficient storage and access to the base model based on a desired level of detail.

The following clauses summarize various examples of the techniques of this disclosure:
Clause 1: A method of storing media data, the method comprising: storing a three-dimensional (3D) object model in an ISO base media file format (ISO BMFF) file, including: storing metadata for the 3D object model in the ISO BMFF file; storing a number of levels of detail (LODs) for the 3D object model in the ISO BMFF file; and for each of the number of LODs, storing data associating the LOD with data representing a size, complexity, and components of the 3D object model for the LOD in the ISO BMFF file.
Clause 2: The method of clause 1, wherein storing the 3D object model comprises storing the 3D object model as a base avatar model (BAVM) box as an extension of a FullBox of ISO BMFF.
Clause 3: The method of any of clauses 1 and 2, wherein storing the data associating the LOD with the data representing the size, complexity, and components of the 3D object model for the LOD comprises storing a base model mapping structure in the ISO BMFF file.
Clause 4: The method of any of clauses 1-3, wherein the data representing the size, complexity, and components of the 3D object model for the LOD comprises a size value, a number of mesh faces, a number of components, and for each of the number of components, data representative of a corresponding component.
Clause 5: The method of clause 4, wherein storing the data representing the size, complexity, and components of the 3D object model for the LOD comprises storing a base model mapping (BMMA) box as an extension of a FullBox of ISO BMFF.
Clause 6: The method of any of clauses 4 and 5, wherein the data representative of the corresponding component comprises one or more of data representing a geometry of the component or one or more images of the component.
Clause 7: The method of any of clauses 4-6, further comprising for each of the components, storing data describing a role of the component for the 3D object model.
Clause 8: The method of clause 7, wherein the role comprises one or more of a joint, a blendshape, a mesh, a map, or a pose transform.
Clause 9: The method of any of clauses 4-8, wherein storing the data representing the components of the 3D object model for the LOD comprises storing each component separately as a respective metadata item in the ISO BMFF file.
Clause 10: The method of clause 9, wherein storing each component separately as the respective metadata item comprises storing each component as a base model component (BMCP) box as an extension of a FullBox of ISOBMFF.
Clause 11: The method of any of clauses 9 and 10, wherein storing each component separately as a respective metadata item in the ISO BMFF file comprises storing, for each of the components, a type value representing a type for the component and an encoding value representing how the component is encoded.
Clause 12: The method of any of clauses 4-11, further comprising encrypting data for one or more of the components.
Clause 13: The method of any of clauses 4-12, wherein storing the data representative of the components comprises storing the data representative of the components hierarchically such that each component having a parent component includes data identifying the parent component.
Clause 14: The method of any of clauses 1-13, further comprising publishing an identifier for the ISO BMFF file to an application server (AS) in a computer network.
Clause 15: The method of any of clauses 1-14, further comprising receiving a request for access to the 3D object model at one of the LODs from a receiving device.
Clause 16: The method of clause 15, further comprising providing the data representing the size, complexity, and components of the 3D object model for the requested one of the LODs to the receiving device in response to the request.
Clause 17: A method of retrieving media data, the method comprising: retrieving data representing a three-dimensional (3D) object model and one or more levels of detail (LODs) for the 3D object model; sending a request to access to data for the 3D object model at one of the LODs, the data for the 3D object model at the one of the LODs including a size, complexity, and components of the 3D object model for the LOD; and receiving data representing the size, complexity, and components of the 3D object model for the LOD in response to the request.
Clause 18: The method of clause 17, wherein the data associating the LOD with the data representing the size, complexity, and components of the 3D object model for the LOD comprises a base model mapping structure.
Clause 19: The method of any of clauses 17 and 18, wherein the data representing the size, complexity, and components of the 3D object model for the LOD comprises a size value, a number of mesh faces, a number of components, and for each of the number of components, data representative of a corresponding component.
Clause 20: The method of clause 19, wherein the data representing the size, complexity, and components of the 3D object model for the LOD comprises a base model mapping (BMMA) box comprising an extension of a FullBox of ISO BMFF.
Clause 21: The method of any of clauses 19 and 20, wherein the data representative of the corresponding component comprises one or more of data representing a geometry of the component or one or more images of the component.
Clause 22: The method of any of clauses 19-21, further comprising for each of the components, retrieving data describing a role of the component for the 3D object model.
Clause 23: The method of clause 22, wherein the role comprises one or more of a joint, a blendshape, a mesh, a map, or a pose transform.
Clause 24: The method of any of clauses 19-23, wherein the data representing the components of the 3D object model for the LOD comprises separate respective metadata items for each of the components.
Clause 25: The method of clause 24, wherein each of the separate respective metadata items comprises a respective base model component (BMCP) box comprising an extension of a FullBox of ISOBMFF.
Clause 26: The method of any of clauses 24 and 25, wherein each of the components includes a type value representing a type for the component and an encoding value representing how the component is encoded.
Clause 27: The method of any of clauses 19-26, further comprising decrypting data for one or more of the components.
Clause 28: The method of clause 27, further comprising retrieving decryption keys for each of the encrypted components.
Clause 29: The method of any of clauses 19-28, wherein the data representative of the components comprises a hierarchical representation of the components such that each component having a parent component includes data identifying the parent component.
Clause 30: A device for transporting media data, the device comprising one or more means for performing the method of any of clauses 1-29.
Clause 31: The device of clause 30, wherein the one or more means comprise a processing system comprising one or more processors implemented in circuitry.
Clause 32: The apparatus of clause 30, wherein the device comprises at least one of: an integrated circuit; a microprocessor; or a wireless communication device.
Clause 33: A device for storing media data, the device comprising: means for storing a three-dimensional (3D) object model in an ISO base media file format (ISO BMFF) file, including: means for storing metadata for the 3D object model in the ISO BMFF file; means for storing a number of levels of detail (LODs) for the 3D object model in the ISO BMFF file; and means for storing, for each of the number of LODs, data associating the LOD with data representing a size, complexity, and components of the 3D object model for the LOD in the ISO BMFF file.
Clause 34: A device for retrieving media data, the device comprising: means for retrieving data representing a three-dimensional (3D) object model and one or more levels of detail (LODs) for the 3D object model; means for sending a request to access to data for the 3D object model at one of the LODs, the data for the 3D object model at the one of the LODs including a size, complexity, and components of the 3D object model for the LOD; and means for receiving data representing the size, complexity, and components of the 3D object model for the LOD in response to the request.
Clause 35: A computer-readable storage medium having stored thereon instructions that, when executed, cause a processor to perform the method of any of clauses 1-29.
Clause 36: A method of storing media data, the method comprising: storing a three-dimensional (3D) object model in an ISO base media file format (ISO BMFF) file, including: storing metadata for the 3D object model in the ISO BMFF file; storing a number of levels of detail (LODs) for the 3D object model in the ISO BMFF file; and for each of the number of LODs, storing data associating the LOD with data representing a size, complexity, and components of the 3D object model for the LOD in the ISO BMFF file.
Clause 37: The method of clause 36, wherein storing the 3D object model comprises storing the 3D object model as a base avatar model (BAVM) box as an extension of a FullBox of ISO BMFF.
Clause 38: The method of clause 36, wherein storing the data associating the LOD with the data representing the size, complexity, and components of the 3D object model for the LOD comprises storing a base model mapping structure in the ISO BMFF file.
Clause 39: The method of clause 36, wherein the data representing the size, complexity, and components of the 3D object model for the LOD comprises a size value, a number of mesh faces, a number of components, and for each of the number of components, data representative of a corresponding component.
Clause 40: The method of clause 39, wherein storing the data representing the size, complexity, and components of the 3D object model for the LOD comprises storing a base model mapping (BMMA) box as an extension of a FullBox of ISO BMFF.
Clause 41: The method of clause 39, wherein the data representative of the corresponding component comprises one or more of data representing a geometry of the component or one or more images of the component.
Clause 42: The method of clause 39, further comprising for each of the components, storing data describing a role of the component for the 3D object model.
Clause 43: The method of clause 42, wherein the role comprises one or more of a joint, a blendshape, a mesh, a map, or a pose transform.
Clause 44: The method of clause 39, wherein storing the data representing the components of the 3D object model for the LOD comprises storing each component separately as a respective metadata item in the ISO BMFF file.
Clause 45: The method of clause 44, wherein storing each component separately as the respective metadata item comprises storing each component as a base model component (BMCP) box as an extension of a FullBox of ISOBMFF.
Clause 46: The method of clause 44, wherein storing each component separately as a respective metadata item in the ISO BMFF file comprises storing, for each of the components, a type value representing a type for the component and an encoding value representing how the component is encoded.
Clause 47: The method of clause 39, further comprising encrypting data for one or more of the components.
Clause 48: The method of clause 39, wherein storing the data representative of the components comprises storing the data representative of the components hierarchically such that each component having a parent component includes data identifying the parent component.
Clause 49: The method of clause 36, further comprising publishing an identifier for the ISO BMFF file to an application server (AS) in a computer network.
Clause 50: The method of clause 36, further comprising receiving a request for access to the 3D object model at one of the LODs from a receiving device.
Clause 51: The method of clause 50, further comprising providing the data representing the size, complexity, and components of the 3D object model for the requested one of the LODs to the receiving device in response to the request.
Clause 52: A method of retrieving media data, the method comprising: retrieving data representing a three-dimensional (3D) object model and one or more levels of detail (LODs) for the 3D object model; sending a request to access to data for the 3D object model at one of the LODs, the data for the 3D object model at the one of the LODs including a size, complexity, and components of the 3D object model for the LOD; and receiving data representing the size, complexity, and components of the 3D object model for the LOD in response to the request.
Clause 53: The method of clause 52, wherein the data associating the LOD with the data representing the size, complexity, and components of the 3D object model for the LOD comprises a base model mapping structure.
Clause 54: The method of clause 52, wherein the data representing the size, complexity, and components of the 3D object model for the LOD comprises a size value, a number of mesh faces, a number of components, and for each of the number of components, data representative of a corresponding component.
Clause 55: The method of clause 54, wherein the data representing the size, complexity, and components of the 3D object model for the LOD comprises a base model mapping (BMMA) box comprising an extension of a FullBox of ISO BMFF.
Clause 56: The method of clause 54, wherein the data representative of the corresponding component comprises one or more of data representing a geometry of the component or one or more images of the component.
Clause 57: The method of clause 54, further comprising for each of the components, retrieving data describing a role of the component for the 3D object model.
Clause 58: The method of clause 57, wherein the role comprises one or more of a joint, a blendshape, a mesh, a map, or a pose transform.
Clause 59: The method of clause 54, wherein the data representing the components of the 3D object model for the LOD comprises separate respective metadata items for each of the components.
Clause 60: The method of clause 59, wherein each of the separate respective metadata items comprises a respective base model component (BMCP) box comprising an extension of a FullBox of ISOBMFF.
Clause 61: The method of clause 59, wherein each of the components includes a type value representing a type for the component and an encoding value representing how the component is encoded.
Clause 62: The method of clause 54, further comprising decrypting data for one or more of the components.
Clause 63: The method of clause 62, further comprising retrieving decryption keys for each of the encrypted components.
Clause 64: The method of clause 54, wherein the data representative of the components comprises a hierarchical representation of the components such that each component having a parent component includes data identifying the parent component.
Clause 65: A method of storing media data, the method comprising: storing a three-dimensional (3D) object model in an ISO base media file format (ISO BMFF) file, including: storing metadata for the 3D object model in the ISO BMFF file; storing a number of levels of detail (LODs) for the 3D object model in the ISO BMFF file; and for each of the number of LODs, storing data associating the LOD with data representing a size, complexity, and components of the 3D object model for the LOD in the ISO BMFF file.
Clause 66: The method of claim 65, wherein storing the 3D object model comprises storing the 3D object model as a base avatar model (BAVM) box as an extension of a FullBox of ISO BMFF.
Clause 67: The method of claim 65, wherein storing the data associating the LOD with the data representing the size, complexity, and components of the 3D object model for the LOD comprises storing a base model mapping structure in the ISO BMFF file.
Clause 68: The method of claim 65, wherein the data representing the size, complexity, and components of the 3D object model for the LOD comprises a size value, a number of mesh faces, a number of components, and for each of the number of components, data representative of a corresponding component.
Clause 69: The method of clause 68, wherein storing the data representing the size, complexity, and components of the 3D object model for the LOD comprises storing a base model mapping (BMMA) box as an extension of a FullBox of ISO BMFF.
Clause 70: The method of clause 68, wherein the data representative of the corresponding component comprises one or more of data representing a geometry of the component or one or more images of the component.
Clause 71: The method of clause 68, further comprising for each of the components, storing data describing a role of the component for the 3D object model.
Clause 72: The method of clause 71, wherein the role comprises one or more of a joint, a blendshape, a mesh, a map, or a pose transform.
Clause 73: The method of clause 68, wherein storing the data representing the components of the 3D object model for the LOD comprises storing each component separately as a respective metadata item in the ISO BMFF file.
Clause 74: The method of clause 73, wherein storing each component separately as the respective metadata item comprises storing each component as a base model component (BMCP) box as an extension of a FullBox of ISOBMFF.
Clause 75: The method of clause 73, wherein storing each component separately as a respective metadata item in the ISO BMFF file comprises storing, for each of the components, a type value representing a type for the component and an encoding value representing how the component is encoded.
Clause 76: The method of clause 68, further comprising encrypting data for one or more of the components.
Clause 77: The method of clause 68, wherein storing the data representative of the components comprises storing the data representative of the components hierarchically such that each component having a parent component includes data identifying the parent component.
Clause 78: The method of claim 65, further comprising publishing an identifier for the ISO BMFF file to an application server (AS) in a computer network.
Clause 79: The method of claim 65, further comprising receiving a request for access to the 3D object model at one of the LODs from a receiving device.
Clause 80: The method clause 79, further comprising providing the data representing the size, complexity, and components of the 3D object model for the requested one of the LODs to the receiving device in response to the request.
Clause 81: A device for storing media data, the device comprising: a memory for storing media data; and a processing system implemented in circuitry and configured to store a three-dimensional (3D) object model in an ISO base media file format (ISO BMFF) file of the media data in the memory, wherein to store the 3D object model in the ISO BMFF file, the processing system is configured to: store metadata for the 3D object model in the ISO BMFF file; store a number of levels of detail (LODs) for the 3D object model in the ISO BMFF file; and for each of the number of LODs, store data associating the LOD with data representing a size, complexity, and components of the 3D object model for the LOD in the ISO BMFF file.
Clause 82: A method of retrieving media data, the method comprising: retrieving, by a client device, data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device; sending, by the client device, a request to the server device to access data for the 3D object model at one of the LODs, the data for the 3D object model at the one of the LODs including a size, complexity, and components of the 3D object model for the one of the LODs; and receiving, by the client device, the data for the 3D object model at the one of the LODs in response to the request, the data for the 3D object model at the one of the LODs having the size, the complexity, and the components of the 3D object model for the one of the LODs.
Clause 83: The method of clause 82, wherein the data associating the LOD with the data representing the size, complexity, and components of the 3D object model for the LOD comprises a base model mapping structure.
Clause 84: The method of clause 82, wherein the data representing the size, complexity, and components of the 3D object model for the LOD comprises a size value, a number of mesh faces, a number of components, and for each of the number of components, data representative of a corresponding component.
Clause 85: The method of clause 84, wherein the data representing the size, complexity, and components of the 3D object model for the LOD comprises a base model mapping (BMMA) box comprising an extension of a FullBox of ISO BMFF.
Clause 86: The method of clause 84, wherein the data representative of the corresponding component comprises one or more of data representing a geometry of the component or one or more images of the component.
Clause 87: The method of clause 84, further comprising for each of the components, retrieving data describing a role of the component for the 3D object model.
Clause 88: The method of clause 87, wherein the role comprises one or more of a joint, a blendshape, a mesh, a map, or a pose transform.
Clause 89: The method of clause 84, wherein the data representing the components of the 3D object model for the LOD comprises separate respective metadata items for each of the components.
Clause 90: The method of clause 89, wherein each of the separate respective metadata items comprises a respective base model component (BMCP) box comprising an extension of a FullBox of ISOBMFF.
Clause 91: The method of clause 89, wherein each of the components includes a type value representing a type for the component and an encoding value representing how the component is encoded.
Clause 92: The method of clause 84, further comprising: retrieving decryption keys for each of the encrypted components; and decrypting data for one or more of the components using the decryption keys.
Clause 93: The method of clause 84, wherein the data representative of the components comprises a hierarchical representation of the components such that each component having a parent component includes data identifying the parent component.
Clause 94: A client device for retrieving media data, the device comprising: a memory for storing media data; and a processing system implemented in circuitry and configured to: retrieve data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device; send a request to the server device to access data for the 3D object model at one of the LODs, the data for the 3D object model at the one of the LODs including a size, complexity, and components of the 3D object model for the one of the LODs; and receive the data for the 3D object model at the one of the LODs in response to the request, the data for the 3D object model at the one of the LODs having the size, the complexity, and the components of the 3D object model for the one of the LODs.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of storing media data, the method comprising:
storing a three-dimensional (3D) object model in an ISO base media file format (ISO BMFF) file, including:
storing metadata for the 3D object model in the ISO BMFF file;
storing a number of levels of detail (LODs) for the 3D object model in the ISO BMFF file; and
for each of the number of LODs, storing data associating the LOD with data representing a size, complexity, and components of the 3D object model for the LOD in the ISO BMFF file.

2. The method of claim 1, wherein storing the 3D object model comprises storing the 3D object model as a base avatar model (BAVM) box as an extension of a FullBox of ISO BMFF.

3. The method of claim 1, wherein storing the data associating the LOD with the data representing the size, complexity, and components of the 3D object model for the LOD comprises storing a base model mapping structure in the ISO BMFF file.

4. The method of claim 1, wherein the data representing the size, complexity, and components of the 3D object model for the LOD comprises a size value, a number of mesh faces, a number of components, and for each of the number of components, data representative of a corresponding component.

5. The method of claim 4, wherein storing the data representing the size, complexity, and components of the 3D object model for the LOD comprises storing a base model mapping (BMMA) box as an extension of a FullBox of ISO BMFF.

6. The method of claim 4, wherein the data representative of the corresponding component comprises one or more of data representing a geometry of the component or one or more images of the component.

7. The method of claim 4, further comprising for each of the components, storing data describing a role of the component for the 3D object model.

8. The method of claim 7, wherein the role comprises one or more of a joint, a blendshape, a mesh, a map, or a pose transform.

9. The method of claim 4, wherein storing the data representing the components of the 3D object model for the LOD comprises storing each component separately as a respective metadata item in the ISO BMFF file.

10. The method of claim 9, wherein storing each component separately as the respective metadata item comprises storing each component as a base model component (BMCP) box as an extension of a FullBox of ISOBMFF.

11. The method of claim 9, wherein storing each component separately as a respective metadata item in the ISO BMFF file comprises storing, for each of the components, a type value representing a type for the component and an encoding value representing how the component is encoded.

12. The method of claim 4, further comprising encrypting data for one or more of the components.

13. The method of claim 4, wherein storing the data representative of the components comprises storing the data representative of the components hierarchically such that each component having a parent component includes data identifying the parent component.

14. The method of claim 1, further comprising publishing an identifier for the ISO BMFF file to an application server (AS) in a computer network.

15. The method of claim 1, further comprising receiving a request for access to the 3D object model at one of the LODs from a receiving device.

16. The method of claim 15, further comprising providing the data representing the size, complexity, and components of the 3D object model for the requested one of the LODs to the receiving device in response to the request.

17. A device for storing media data, the device comprising:
a memory for storing media data; and
a processing system implemented in circuitry and configured to store a three-dimensional (3D) object model in an ISO base media file format (ISO BMFF) file of the media data in the memory, wherein to store the 3D object model in the ISO BMFF file, the processing system is configured to:
store metadata for the 3D object model in the ISO BMFF file;
store a number of levels of detail (LODs) for the 3D object model in the ISO BMFF file; and
for each of the number of LODs, store data associating the LOD with data representing a size, complexity, and components of the 3D object model for the LOD in the ISO BMFF file.

18. A method of retrieving media data, the method comprising:
retrieving, by a client device, data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device;
sending, by the client device, a request to the server device to access data for the 3D object model at one of the LODs, the data for the 3D object model at the one of the LODs including a size, complexity, and components of the 3D object model for the one of the LODs; and
receiving, by the client device, the data for the 3D object model at the one of the LODs in response to the request, the data for the 3D object model at the one of the LODs having the size, the complexity, and the components of the 3D object model for the one of the LODs.

19. The method of claim 18, wherein the data associating the LOD with the data representing the size, complexity, and components of the 3D object model for the LOD comprises a base model mapping structure.

20. The method of claim 18, wherein the data representing the size, complexity, and components of the 3D object model for the LOD comprises a size value, a number of mesh faces, a number of components, and for each of the number of components, data representative of a corresponding component.

21. The method of claim 20, wherein the data representing the size, complexity, and components of the 3D object model for the LOD comprises a base model mapping (BMMA) box comprising an extension of a FullBox of ISO BMFF.

22. The method of claim 20, wherein the data representative of the corresponding component comprises one or more of data representing a geometry of the component or one or more images of the component.

23. The method of claim 20, further comprising for each of the components, retrieving data describing a role of the component for the 3D object model.

24. The method of claim 23, wherein the role comprises one or more of a joint, a blendshape, a mesh, a map, or a pose transform.

25. The method of claim 20, wherein the data representing the components of the 3D object model for the LOD comprises separate respective metadata items for each of the components.

26. The method of claim 25, wherein each of the separate respective metadata items comprises a respective base model component (BMCP) box comprising an extension of a FullBox of ISOBMFF.

27. The method of claim 25, wherein each of the components includes a type value representing a type for the component and an encoding value representing how the component is encoded.

28. The method of claim 20, wherein one or more of the components comprise encrypted components, the method further comprising:
retrieving decryption keys for each of the encrypted components; and
decrypting data for the encrypted components using the decryption keys.

29. The method of claim 20, wherein the data representative of the components comprises a hierarchical representation of the components such that each component having a parent component includes data identifying the parent component.

30. A client device for retrieving media data, the device comprising:
a memory for storing media data; and
a processing system implemented in circuitry and configured to:
retrieve data representing a three-dimensional (3D) object model stored in an ISO base media file format (ISO BMFF) file and one or more levels of detail (LODs) for the 3D object model stored in the ISO BMFF file, wherein the ISO BMFF file is stored on a server device;
send a request to the server device to access data for the 3D object model at one of the LODs, the data for the 3D object model at the one of the LODs including a size, complexity, and components of the 3D object model for the one of the LODs; and
receive the data for the 3D object model at the one of the LODs in response to the request, the data for the 3D object model at the one of the LODs having the size, the complexity, and the components of the 3D object model for the one of the LODs.
